(19) United States
(12) Patent Application Publication
(10) Pub. No.: US 2010/0085133 A1
(43) Pub. Date: Apr. 8, 2010

(54) TRIPLATE LINE-TO-WAVEGUIDE TRANSDUCER

(76) Inventors: Taketo Nomura, Ibaraki (JP); Masahiko Oota, Tochigi (JP); Hisayoshi Mizugaki, Ibaraki (JP); Yuichi Shimayama, Ibaraki (JP); Takashi Saitou, Ibaraki (JP); Masaya Kirihara, Ibaraki (JP); Keisuke Iijima, Ibaraki (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/532,551

(22) PCT Filed: Feb. 26, 2008
(86) PCT No.: PCT/JP2008/053300

§ 371 Date: Sep. 22, 2009

(30) Foreign Application Priority Data
Mar. 22, 2007 (JP) 2007-074529
May 24, 2007 (JP) 2007-138194

(51) Int. Cl. H01P 1/00

(52) U.S. Cl. 333/248

(57) ABSTRACT

A ground conductor (1) has a through hole provided through an area thereof for connection with a waveguide (6), with dimensions substantially equal to cavity dimensions of the waveguide (6), and a metallic spacer (7a) is provided as a holding element for a film substrate (4), with an even thickness to a dielectric substrate (2a), the metallic spacer (7a) having dimensions E1 and E2 of cavity walls thereof changed in accordance with a desirable frequency, and cooperating with another metallic spacer (7b) having substantially equal dimensions to the metallic spacer (7a), to sandwich the film substrate (4) in between, and in addition, an upper ground conductor (5) is arranged on the other metallic spacer (7b), and a quadrate resonant patch pattern (8) is formed at an end of the strip line conductor (3) formed to the film subs ate (4), on an area corresponding to a transducer end of the waveguide (6), while a combination of the quadrate resonant patch pattern (8) and the waveguide (6) is arranged such that the quadrate resonant patch pattern (8) has a center position thereof coincident with a center position of the cavity dimensions of the waveguide (6).

### TECHNICAL FIELD

The present invention relates to a triplate line-to-waveguide transducer with a structure for millimeter wavelengths.

### BACKGROUND ART

Recent planer antennas for microwaves or millimeter wavelengths have an electric feed-through system configured as a triplate transmission line to provide a highly efficient characteristic, as a prevailing trend. Planner antennas of such a triplate line feed-through system are adapted to synthesize power fed from antenna elements through the triplate transmission line, and in most cases they have, at an interconnect between a final end that outputs synthesized power and an RF signal processing circuit, a triplate line-to-waveguide transducer implementing facile fabrication and high connection integrity.

FIG. 1 illustrates configuration of such a triplate line-to-waveguide transducer in the past (refer e.g. to Japanese Utility Model Registration Application Laid-Open Publication No. 06-070305 and Japanese Patent Application Laid-Open Publication No. 2004-215050). In the conventional configuration, in order for the conversion for waveguide system to be facilitated with a small loss, there was a triplate transmission line made up by: a film substrate 4 formed with a strip line conductor 3, and laminated over a surface of a ground conductor 1, with a dielectric substrate 2a in between; and an upper ground conductor 5 laminated over a surface of the film substrate, with another dielectric substrate 2b in between.

Moreover, for connection of such the circuit system to an input portion of a waveguide 6, the ground conductor 1 had a through hole with dimensions substantially equal to cavity dimensions of the waveguide 6. Further, the film substrate 4 was held by provision of a metallic spacer 7a with an even thickness to the dielectric substrate 2a, and another metallic spacer 7b with substantially equal dimensions to that metallic spacer 7a, with the film substrate in between, and this metallic spacer 7b had an upper ground conductor 5 arranged thereon. And, the strip line conductor 3 formed on the film substrate 4 had a square resonant patch pattern 8 formed on an area corresponding to a transducer end of the waveguide 6. The square resonant patch pattern 8 had a center position thereof coincident with a center position of cavity dimensions of the waveguide 6. The triplate line-to-waveguide transducer was thus made up.

As illustrated in FIG. 1(a), the square resonant patch pattern 8 had a dimension L1 in a direction in which the line was connected, and a dimension L2 in a direction perpendicular to the direction of line connection, as a prescribed dimension, permitting implementation of the triplate line-to-waveguide transducer with a low-loss characteristic over a wide bandwidth within a desirable range of frequencies.

In the conventional configuration of triplate line-to-waveguide transducer illustrated in FIG. 1, the square resonant patch pattern 8 had dimensions thereof restricted by cavity wall dimensions of the metallic spacers 7a and 7b, with a resultant restriction to the lower limit of resonance frequency, as an issue.

### DISCLOSURE OF INVENTION

It is an object of the present invention to provide a triplate line-to-waveguide transducer allowing for facile fabrication and high connection integrity, at a low cost, with a minimized lower limit of resonance frequency relative to the conventional configuration, without detriment to the low-loss characteristic over a wide bandwidth in the past.

According to an aspect of the present invention, as illustrated in FIG. 2, a triplate line-to-waveguide transducer includes a transducer portion configured with and between a waveguide 6 and a triplate transmission line comprised of a film substrate 4 formed with a strip line conductor 3 and laminated over a surface of a ground conductor 1, with a dielectric substrate 2a in between, and an upper ground conductor 5 laminated over a surface of the film substrate, with another dielectric substrate 2b in between, and the triplate line-to-waveguide transducer comprises a through hole provided through an area on the ground conductor 1 for connection with the waveguide, with dimensions substantially equal to cavity dimensions of the waveguide 6, a metallic spacer 7a provided as a holding element for the film substrate 4, with an even thickness to the dielectric substrate 2a, and cooperating with another metallic spacer 7b having substantially equal dimensions to the metallic spacer 7a, to sandwich the film substrate (4) in between, the upper ground conductor 5 being arranged on the other metallic spacer 7b, a quadrate resonant patch pattern 8 formed at an end of the strip line conductor 3 formed to the film substrate 4, on an area corresponding to a transducer end of the waveguide 6, and a combination of the quadrate resonant patch pattern (8) and the waveguide (6) arranged for the quadrate resonant patch pattern 8 to have a center position thereof coincident with a center position of the cavity dimensions of the waveguide 6.

According to another aspect of the present invention, as illustrated in FIG. 2, in the triplate line-to-waveguide transducer, the quadrate resonant patch pattern 8 has a dimension L1 thereof in a direction of line connection set up as a free space wavelength λ₀ of desirable frequency times approximately 0.32, and a dimension L2 thereof in a direction perpendicular to the direction of line connection set up as the free space wavelength λ₀ of desirable frequency times approximately 0.38.

According to another aspect of the present invention, as illustrated in FIG. 2, in the triplate line-to-waveguide transducer, those dimensions E1 and E2 of cavity walls of the metallic spacers 7a and 7b illustrated in FIG. 3(b) are set up as a free space wavelength λ₀ of desirable frequency times approximately 0.59.

According to the present invention, a triplate line-to-waveguide transducer is made up by component members such as a ground conductor 1, an upper ground conductor 5, and metallic spacers 7a and 7b that can be fabricated at a low cost by a punching, such as of a metallic plate with a desirable thickness, allowing for facile fabrication and high connection integrity, at a low cost, with a minimized lower limit of resonance frequency relative to a conventional configuration, without detriment to a low-loss characteristic over a wide bandwidth in the past.

### BRIEF DESCRIPTION OF DRAWINGS

In FIG. 1, (a) is a plan view of a conventional example, and (b), a sectional view thereof.

In FIG. 2, (a) is a plan view of an embodiment of the present invention, and (b), a sectional view thereof.

In FIG. 3, (a) to (c) are plan views of parts according to embodiment examples of the present invention.

FIG. 4 is a sectional view describing conversion of excitation modes according to the present invention.

FIG. 5 is a graphic representation of a relationship between return loss and frequency according to an embodiment example of the present invention.

### BEST MODE FOR CARRYING OUT THE INVENTION

There will be described into details an embodiment of triplate line-to-waveguide transducer according to the present invention, with reference to the drawings.

FIG. 2 illustrates the triplate line-to-waveguide transducer, which includes a triplate transmission line that is made up, in order for the conversion for waveguide system to be facilitated with a smell loss, by: a film substrate 4 formed with a strip line conductor 3, and laminated over a surface of a ground conductor 1, with a dielectric substrate 2a in between; and an upper ground conductor 5 laminated over a surface of the film substrate, with another dielectric substrate 2b in between.

Moreover, for connection of the circuit system to an input portion of a waveguide 6, the ground conductor 1 has a through hole provided with dimensions substantially equal to cavity dimensions of the waveguide 6, i.e., a×b (refer to FIG. 3(a)). The through hole may well be an elliptic. Further, the film substrate 4 is held by provision of a combination of a metallic spacer 7a with an even thickness to the dielectric substrate 2a, and another metallic spacer 7b with substantially equal dimensions to that metallic spacer 7a, with the film substrate in between. This metallic spacer 7b has an upper ground conductor 5 arranged thereon. And, the strip line conductor 3 formed on the film substrate 4 has a quadrate resonant patch pattern 8 formed on an area corresponding to a transducer end of the waveguide 6. The quadrate resonant patch pattern 8 has a center position thereof coincident with a center position of the cavity dimensions of waveguide 6. The triplate line-to-waveguide transducer is thus made up.

FIG. 3(b) illustrates metallic spacers 7a and 7b as parts of the triplate line-to-waveguide transducer shown in FIG. 2 in accordance with the present invention. Such parts may well be fabricated by punching a metal plate of a desirable thickness.

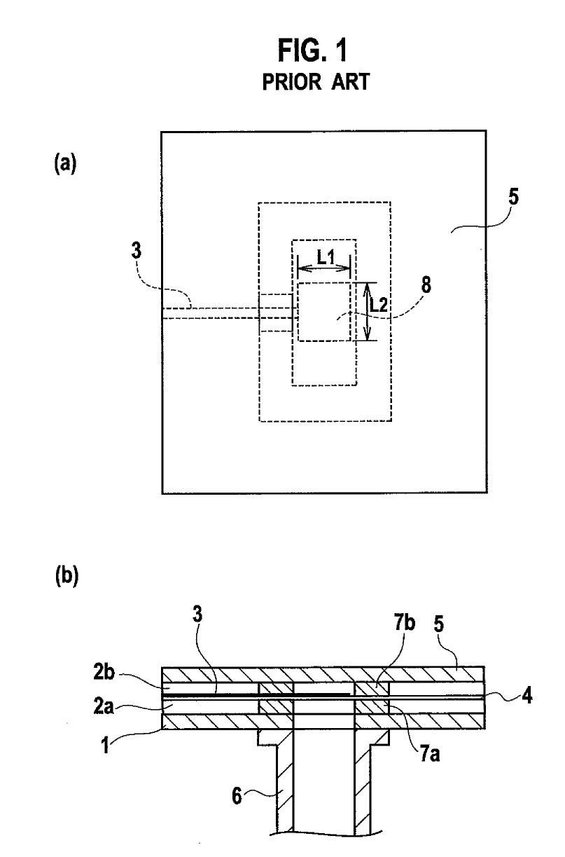

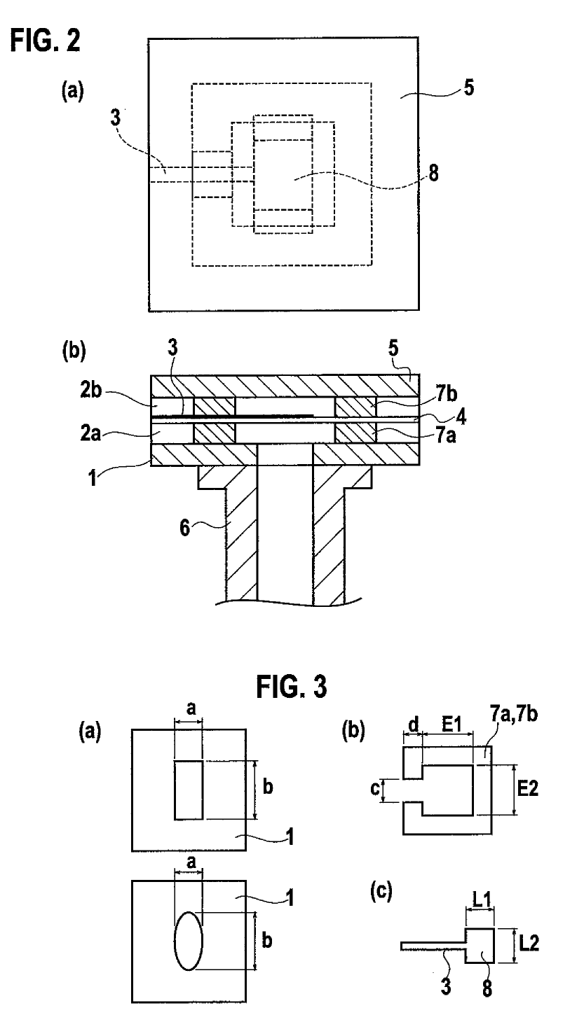

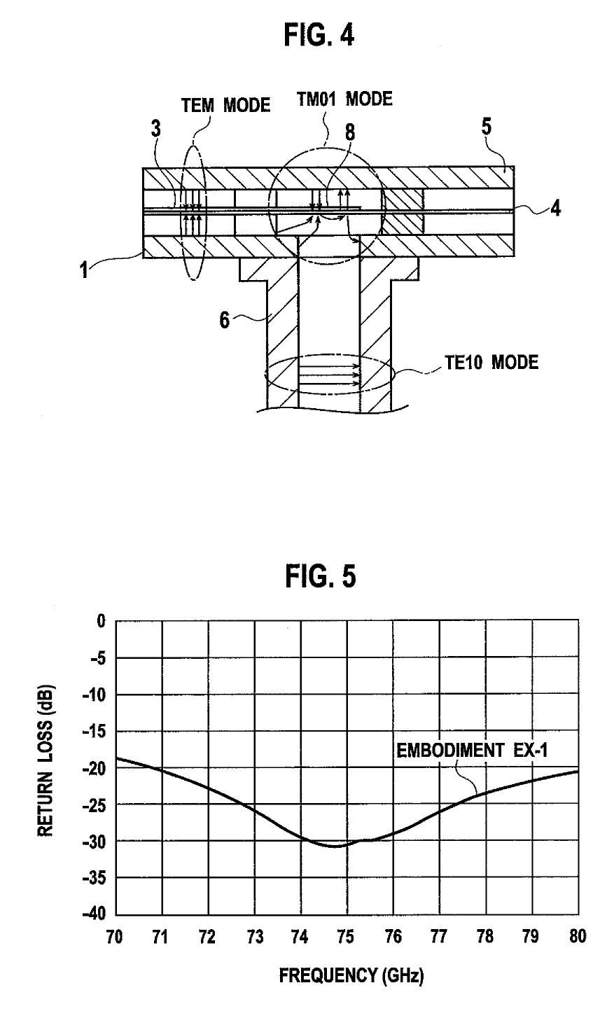

In this invention, as illustrated in FIG. 4, for instance, the quadrate resonant patch pattern 8 is formed on a surface area of the film substrate 4, and cooperates with the upper ground conductor 5 to have an excitation mode TM01 excited in between. In this connection, the triplate transmission line is configured with the strip line conductor 3 formed on a surface region of the film substrate 4 between ground conductors 1 and 5, and has an excitation mode TEM, which is transduced to the mode TM01 between quadrate resonant patch pattern 8 and ground conductor 5, which mode is to be transduced to an excitation mode TE10 in the waveguide of a quadrate form.

The component parts are to be assembled with an established coincidence among a center position of the quadrate resonant patch pattern 8, a center position of cavity dimensions of the waveguide 6, a center position of the through hole of ground conductor 1, and center positions of cavity walls of dimensions E1 by E2 (in FIG. 3(b)) of the metallic spacers 7a and 7b. The component parts may well be assembled by use of guide pins or the like for the positioning to be accurate, and fastened for fixation such as by screws.

In this invention, preferably, the quadrate resonant patch pattern 8 should have (as illustrated in FIG. 3(c)) a dimension L1 thereof in a direction of line connection set up as a free space wavelength λ₀ of desirable frequency times approximately 0.32, and a dimension L2 thereof in a direction perpendicular to the direction of line connection set up as the free space wavelength λ₀ of desirable frequency times approximately 0.38.

The L1 as set to the free space wavelength λ₀ of desirable frequency times approximately 0.32 comes near the cavity dimension ‘a’ of waveguide times approximately 0.98, enabling a smooth conversion of different modes of electric and magnetic waves. This is why that setting should be done. Preferable in that respect is the free space wavelength λ₀ times a factor within a range of 0.32 to 0.34. The L2 as set to the free space wavelength λ₀ of desirable frequency times approximately 0.38 renders an extended bandwidth available as a bandwidth that allows for a secured return loss, which is why this setting should be done. Preferable in this respect is the free space wavelength λ₀ times a factor within a range of 0.32 to 0.4.

In this invention, preferably, the metallic spacers 7a and 7b should have dimensions E1 and E2 of cavity walls thereof in FIG. 3(b) set up as the free space wavelength λ₀ of desirable frequency times approximately 0.59. The dimensions E1 and E2 as set to the free space wavelength λ₀ of desirable frequency times approximately 0.59 ease up the restriction to dimensions of the quadrate resonant patch pattern 8, allowing for a minimized lower limit of resonant frequency. This is why the setting should be done. Preferable in this respect is the free space wavelength λ₀ times a factor within a range of 0.56 to 0.62.

The film substrate 4 employs a film as a substrate, which may well be a flexible substrate with a metal foil such as a copper foil glued thereon, for instance, of which copper foil (metal foil) segments may be removed by an etching, as necessary, to form, among others, a set of radiation elements with strip conductor lines for their connection. The film substrate may be configured as a copper-glued planer lamination that has a copper foil glued on a thin resin plate in the form of a resin-impregnated glass cloth. The film may be a film of polyethylene, polypropylene, polytetrafluoroethylene, fluorinated ethylene propylene copolymer, ethylene tetrafluoroethylene copolymer, polyamide, polyimide, polyamide-imide, polyarylate, thermoplastic polyimide, polyetherimide, polyether ether ketone, polyethylene terephthalate, polybutylene terephthalate, polystyrene, polysulfone, polyphenylene ether, polyphenylene sulfide, polymethlpentene, or the like. There may be an adhesive agent used for adhesion between film and metal foil. For heat-resistance, dielectric property, and general versatility, preferable is a flexible substrate in the form of a polyimide film with a laminated copper foil. Fluorinated films are preferable for use in view of dielectric characteristics.

For the ground conductor 1 as well as the upper ground conductor 5, there may be use of any metallic plate or plated plastic plate as available, while aluminum plates are preferable from viewpoints of light weight and possible low-cost fabrication. They may be configured as a flexible substrate that has a copper foil glued on a film as a substrate, or as a copper-glued planer lamination that has a copper foil glued on a thin resin plate in the form of a resin-impregnated glass cloth.

The waveguide 6, as well as the through hole provided through the ground conductor 1 with dimensions substantially equal to the cavity dimensions, may preferably have a quadrate shape. This may well be an elliptic shape capable of an equivalent transmission of frequencies with respect to the quadrate shape. For the dielectric substrates 2a and 2b, there may well be use of foam or the like that has a small relative permittivity to the air. The foam may be polyolefin foam such as polyethylene or polypropylene, polystyrene foam, polyurethane foam, polysilicon foam, or rubber foam, while polyolefin foam is preferable as having a smaller relative permittivity to the air.

Description is now made of a specific example of embodiment of the present invention.

FIG. 2 is an illustration of the specific example. In the configuration, employed as the ground conductor 1 was an aluminum plate 3 mm thick; as the dielectric substrates 2a and 2b, polypropylene foam sheets 0.3 mm thick each with a relative permittivity of 1.1; as the film substrate 4, a film substrate in the form of a polyimide film 25 μm thick with a glued copper foil 18 μm thick; and as the ground conductor 5, an aluminum plate 2.0 mm thick Further, as the metallic spacers 7a and 7b, aluminum plates 0.3 mm thick each were used.

The ground conductor 1 was formed, as illustrated in FIG. 3(a), with a through hole punched by the same dimensions as a cavity of the waveguide, such that a=1.27 mm, and b=2.54 mm. The metallic spacers 7a and 7b were punched to form with dimensions shown in FIG. 3(b), such that E1=2.3 mm, E2=2.3 mm, c=1.0 mm, and d=0.85 mm. The film substrate 4 was processed by an etching to form, as illustrated in FIG. 3(c), a combination of a strip line conductor 3 as a straight transmission line with a line width of 0.3 mm, and a quadrate resonant patch pattern 8 at a distal end thereof whereto the waveguide was to be positioned. This pattern had a dimension L1 in a direction of line connection as a free space wavelength λ₀ of desirable frequency times approximately 0.32, i.e., L1=1.25 mm, and a dimension L2 in a direction perpendicular to the direction of line connection as the free space wavelength λ₀ of desirable frequency times approximately 0.38, i.e., L2=1.5 mm.

Component parts of a configuration in part of FIG. 2 were arranged for lamination by use of guide pins and the like inserted therethrough from upside of the upper ground conductor 5, to screw as necessary for fixation to the ground conductor 1, so that they were assembled with an established well-precise coincidence among a center position of the through hole of ground conductor 1, center positions of cavity walls of dimensions E1 by E2 of the metallic spacers 7a and 7b, and a center position of the quadrate resonant patch pattern 8.

By the foregoing arrangement, the configuration in part of FIG. 2 was fabricated as a combination of input and output portions with a bilaterally symmetric appearance. Then, at one end of this, a waveguide was terminated on the output portion. The waveguide was connected to the input portion. Under this condition, reflection characteristics were measured, with results illustrated by solid lines in FIG. 5. There were characteristics of −20 dB or less observed as reflection losses about a desirable frequency of 76.5 GHz. In addition, there were characteristics of low reflection losses of −20 dB or less obtained in a lower range of frequencies than in the past.

### INDUSTRIAL APPLICABILITY

According to the present invention, a triplate line-to-waveguide transducer is made up by component members such as a ground conductor 1, an upper ground conductor 5, and metallic spacers 7a and 7b that can be fabricated at a low cost by a punching, such as of a metallic plate with a desirable thickness, allowing for facile fabrication and high connection integrity, at a low cost, with a minimized lower limit of resonance frequency relative to a conventional configuration, without detriment to a low-loss characteristic over a wide bandwidth in the past.

1. A triplate line-to-waveguide transducer including a transducer portion configured with and between a waveguide and a triplate transmission line comprised of a film substrate formed with a strip line conductor and laminated over a surface of a ground conductor, with a dielectric substrate in between; and an upper ground conductor laminated over a surface of the film substrate, with another dielectric substrate in between, the triplate line-to-waveguide transducer comprising:
a through hole provided through an area on the ground conductor for connection with the waveguide, with dimensions substantially equal to cavity dimensions of the waveguide;
a metallic spacer provided as a holding element for the film substrate, with an even thickness to the dielectric substrate, and cooperating with another metallic spacer having substantially equal dimensions to the metallic spacer, to sandwich the film substrate in between;
the upper ground conductor being arranged on the other metallic spacer;
a quadrate resonant patch pattern formed at an end of the strip line conductor formed to the film substrate, on an area corresponding to a transducer end of the waveguide; and
a combination of the quadrate resonant patch pattern and the waveguide arranged for the quadrate resonant patch pattern to have a center position thereof coincident with a center position of the cavity dimensions of the waveguide.

2. The triplate line-to-waveguide transducer according to claim 1, wherein the quadrate resonant patch pattern has a dimension thereof in a direction of line connection set up as a free space wavelength λ₀ of desirable frequency times approximately 0.32, and a dimension thereof in a direction perpendicular to the direction of line connection set up as the free space wavelength λ₀ of desirable frequency times approximately 0.38.

3. The triplate line-to-waveguide transducer according to claim 1, wherein the metallic spacers have dimensions of cavity walls thereof set up as a free space wavelength λ₀ of desirable frequency times approximately 0.59.

4. The triplate line-to-waveguide transducer according to claim 2, wherein the metallic spacers have dimensions of cavity walls thereof set up as a free space wavelength λ₀ of desirable frequency times approximately 0.59.
